(19) United States
(12) Patent Application Publication
(10) Pub. No.: US 2025/0048310 A1
(43) Pub. Date: Feb. 6, 2025

(54) METHOD FOR REDUCING USER EQUIPMENT TRANSMIT TIMING ERROR GROUP REPORTING OVERHEAD

(71) Applicant: Nokia Technologies Oy, Espoo (FI)

(72) Inventors: Ryan KEATING, Naperville, IL (US); Hyun-Su CHA, Naperville, IL (US)

(21) Appl. No.: 18/682,412

(22) PCT Filed: Oct. 5, 2022
(86) PCT No.: PCT/EP2022/077631

§ 371 Date: Feb. 8, 2024

Related U.S. Application Data
(60) Provisional application No. 63/257,236, filed on Oct. 19, 2021.

(51) Int. Cl. H04W 64/00; H04L 5/00

(52) U.S. Cl. CPC H04W 64/00; H04L 5/0048

(57) ABSTRACT

Systems, methods, apparatuses, and computer program products for reducing user equipment (UE) transmit (Tx) timing error group (TEG) reporting overhead. A method may include receiving, from a first network element, an indication that a sounding reference signal for positioning will be used for uplink and downlink plus uplink positioning. Configuration for the sounding reference signal resource for positioning may be received from a second network element. The sounding reference signal resource for positioning may be associated with a user equipment transmit timing error group. The first network element or the second network element may be informed that a user equipment will report the user equipment transmit timing error group association to the first network element or to the second network element. The user equipment transmit timing error group association may be reported to the first network element or to the second network element.

### FIELD

Some example embodiments may generally relate to mobile or wireless telecommunication systems, such as Long Term Evolution (LTE) or fifth generation (5G) new radio (NR) access technology, or other communications systems. For example, certain example embodiments may relate to apparatuses, systems, and/or methods for reducing user equipment (UE) transmit (Tx) timing error group (TEG) reporting overhead.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include receiving, from a first network element, an indication that a sounding reference signal resource for positioning will be used for uplink and downlink plus uplink positioning. The method may further include receiving, from a second network element, configuration for the sounding reference signal resource for positioning. The method may further include associating the sounding reference signal resource for positioning with a user equipment transmit timing error group. The method may further include informing the first network element or the second network element that a user equipment will report the user equipment transmit timing error group association to the first network element or to the second network element. The method may further include reporting the user equipment transmit timing error group association to the first network element or to the second network element.

Other example embodiments may be directed to an apparatus. The apparatus may include at least one processor and at least one memory including computer program code. The at least one memory and computer program code may also be configured to, with the at least one processor, cause the apparatus at least to receive, from a first network element, an indication that a sounding reference signal resource for positioning will be used for uplink and downlink plus uplink positioning. The at least one memory and computer program code may also be configured to, with the at least one processor, cause the apparatus at least to receive, from a second network element, configuration for the sounding reference signal resource for positioning. The at least one memory and computer program code may also be configured to, with the at least one processor, cause the apparatus at least to associate the sounding reference signal resource for positioning with a user equipment transmit timing error group. The at least one memory and computer program code may also be configured to, with the at least one processor, cause the apparatus at least to inform the first network element or the second network element that a user equipment will report the user equipment transmit timing error group association to the first network element or to the second network element. The at least one memory and computer program code may also be configured to, with the at least one processor, cause the apparatus at least to report the user equipment transmit timing error group association to the first network element or to the second network element.

Other example embodiments may be directed to an apparatus. The apparatus may include means for receiving, from a first network element, an indication that a sounding reference signal resource for positioning will be used for uplink and downlink plus uplink positioning. The apparatus may include means for receiving, from a second network element, configuration for the sounding reference signal resource for positioning. The apparatus may include means for associating the sounding reference signal resource for positioning with a user equipment transmit timing error group. The apparatus may include means for informing the first network element or the second network element that a user equipment will report the user equipment transmit timing error group association to the first network element or to the second network element. The apparatus may include means for reporting the user equipment transmit timing error group association to the first network element or to the second network element.

In accordance with other example embodiments, a non-transitory computer readable medium may be encoded with instructions that may, when executed in hardware, perform a method. The method may include receiving, from a first network element, an indication that a sounding reference signal resource for positioning will be used for uplink and downlink plus uplink positioning. The method may include receiving, from a second network element, configuration for the sounding reference signal resource for positioning. The method may include associating the sounding reference signal resource for positioning with a user equipment transmit timing error group. The method may include informing the first network element or the second network element that a user equipment will report the user equipment transmit timing error group association to the first network element or to the second network element. The method may include reporting the user equipment transmit timing error group association to the first network element or to the second network element.

Other example embodiments may be directed to a computer program product that performs a method. The method may include receiving, from a first network element, an indication that a sounding reference signal resource for positioning will be used for uplink and downlink plus uplink positioning. The method may include receiving, from a second network element, configuration for the sounding reference signal resource for positioning. The method may include associating the sounding reference signal resource for positioning with a user equipment transmit timing error group. The method may include informing the first network element or the second network element that a user equipment will report the user equipment transmit timing error group association to the first network element or to the second network element. The method may include reporting the user equipment transmit timing error group association to the first network element or to the second network element.

Other example embodiments may be directed to an apparatus that may include circuitry configured to receive, from a first network element, an indication that a sounding reference signal resource for positioning will be used for uplink and downlink plus uplink positioning. The apparatus may further include circuitry configured to receive, from a second network element, configuration for the sounding reference signal resource for positioning. The apparatus may further include circuitry configured to associate the sounding reference signal resource for positioning with a user equipment transmit timing error group. The apparatus may further include circuitry configured to inform the first network element or the second network element that a user equipment will report the user equipment transmit timing error group association to the first network element or to the second network element. The apparatus may further include circuitry configured to report the user equipment transmit timing error group association to the first network element or to the second network element.

Certain example embodiments may be directed to a method. The method may include transmitting, to a user equipment, an indication that a sounding reference signal resource for positioning will be used for uplink and downlink plus uplink positioning. The method may include receiving, from the user equipment, an indication that a first network element will report a user equipment transmit timing error group association to a second network element. The method may include receiving a report comprising the user equipment transmit timing error group association. The method may include using the report to tag a positioning measurement with an appropriate user equipment transmit timing error group association.

Other example embodiments may be directed to an apparatus. The apparatus may include at least one processor and at least one memory including computer program code. The at least one memory and computer program code may be configured to, with the at least one processor, cause the apparatus at least to transmit, to a user equipment, an indication that a sounding reference signal resource for positioning will be used for uplink and downlink plus uplink positioning. The at least one memory and computer program code may be configured to, with the at least one processor, cause the apparatus at least to receive, from the user equipment, an indication that a first network element will report a user equipment transmit timing error group association to a second network element. The at least one memory and computer program code may be configured to, with the at least one processor, cause the apparatus at least to receive a report comprising the user equipment transmit timing error group association. The at least one memory and computer program code may be configured to, with the at least one processor, cause the apparatus at least to use the report to tag a positioning measurement with an appropriate user equipment transmit timing error group association.

Other example embodiments may be directed to an apparatus. The apparatus may include means for transmitting, to a user equipment, an indication that a sounding reference signal resource for positioning will be used for uplink and downlink plus uplink positioning. The apparatus may include means for receiving, from the user equipment, an indication that a first network element will report a user equipment transmit timing error group association to a second network element. The apparatus may include means for receiving a report comprising the user equipment transmit timing error group association. The apparatus may include means for using the report to tag a positioning measurement with an appropriate user equipment transmit timing error group association.

In accordance with other example embodiments, a non-transitory computer readable medium may be encoded with instructions that may, when executed in hardware, perform a method. The method may include transmitting, to a user equipment, an indication that a sounding reference signal resource for positioning will be used for uplink and downlink plus uplink positioning. The method may include receiving, from the user equipment, an indication that a first network element will report a user equipment transmit timing error group association to a second network element. The method may include receiving a report comprising the user equipment transmit timing error group association. The method may include using the report to tag a positioning measurement with an appropriate user equipment transmit timing error group association.

Other example embodiments may be directed to a computer program product that performs a method. The method may include transmitting, to a user equipment, an indication that a sounding reference signal resource for positioning will be used for uplink and downlink plus uplink positioning. The method may include receiving, from the user equipment, an indication that a first network element will report a user equipment transmit timing error group association to a second network element. The method may include receiving a report comprising the user equipment transmit timing error group association. The method may include using the report to tag a positioning measurement with an appropriate user equipment transmit timing error group association.

Other example embodiments may be directed to an apparatus that may include circuitry configured to transmit, to a user equipment, an indication that a sounding reference signal resource for positioning will be used for uplink and downlink plus uplink positioning. The apparatus may further include circuitry configured to receive, from the user equipment, an indication that a first network element will report a user equipment transmit timing error group association to a second network element. The apparatus may further include circuitry configured to receive a report comprising the user equipment transmit timing error group association. The apparatus may further include circuitry configured to use the report to tag a positioning measurement with an appropriate user equipment transmit timing error group association.

### BRIEF DESCRIPTION OF THE DRAWINGS

For proper understanding of example embodiments, reference should be made to the accompanying drawings, wherein:

FIG. 1 illustrates an example signal flow diagram, according to certain example embodiments.

FIG. 2 illustrates another example flow diagram, according to certain example embodiments.

FIG. 3 illustrates an example flow diagram of a method, according to certain example embodiments.

FIG. 4 illustrates an example flow diagram of another method, according to certain example embodiments.

FIG. 5(a) illustrates an apparatus, according to certain example embodiments.

FIG. 5(b) illustrates another apparatus, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for power saving for reducing UE Tx TEG reporting overhead.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

Efficient support of various Industrial Internet of Things/URLLC (IIoT/URLLC) use cases have been areas of interest in Third Generation Partnership Project (3GPP) since the release of the 5G design. For certain 5G applications such as, for example, ones that are not supported by traditional telecommunication operators, there may be many new IIoT/URLLC applications/services from different vertical domains such as factory automation, audio/video production, etc. URLLC and time sensitive communications (TSC) communications have been envisioned as key enablers to support existing applications and new emerging applications.

3GPP has begun NR positioning enhancement, focusing on increasing accuracy, reducing latency, and increasing efficiency (i.e., low complexity, low power consumption, or low overhead). Moreover, 3GPP describes specific methods, measurements, signaling, and procedures for improving positioning accuracy of the NR positioning methods by mitigating user equipment (UE) receive/transmit (Rx/Tx) and/or gNB Rx/Tx timing delays including downlink (DL), uplink (UL), and DL+UL positioning methods, and UE-based and UE-assisted positioning solutions.

The positioning accuracy enhancement by mitigating UE Rx/Tx and gNB Rx/Tx timing delays has been discussed in 3GPP, where RANI defines timing error by group delay, and defines the concept of time error group (TEG). For instance, certain elements may be involved with regard to internal timing errors including, for example, a Tx timing error, an Rx timing error, a UE Tx timing error group (UE Tx TEG), a transmission and reception point (TRP) Tx timing error group (TRP Tx TEG), a UE Rx timing error group (UE Rx TEG), a TRP Rx timing error group (TRP Rx TEG), a UE RxTx timing error group (UE RxTx TEG), and a TRP RxTx timing error group (TRP RxTx TEG).

As described in 3GPP, the Tx timing error may be from a signal transmission perspective where there may be a time delay from the time when the digital signal is generated at baseband, to the time when the radio frequency (RF) signal is transmitted from the Tx antenna. For supporting positioning, the UE/TRP may implement an internal calibration/compensation of the Tx time delay for the transmission of the DL PRS/UL SRS signals, which may also include the calibration/compensation of the relative time delay between different RF chains in the same TRP/UE. The compensation may also possibly consider the offset of the Tx antenna phase center to the physical antenna center. However, the calibration may not be perfect. The remaining Tx time delay after the calibration, or the uncalibrated Tx time delay may be defined as a Tx timing error.

As to the Rx timing error, from a signal reception perspective, there may be a time delay from the time when the RF signal arrives at the Rx antenna to the time when the signal is digitized and time-stamped at the baseband. For supporting positioning, the UE/TRP may implement an internal calibration/compensation of the Rx time delay before it reports the measurements that are obtained from the DL PRS/UL SRS signals, which may also include the calibration/compensation of the relative time delay between different RF chains in the same TRP/UE. The compensation may also possibly consider the offset of the Rx antenna phase center to the physical antenna center. However, the calibration may not be perfect. The remaining Rx time delay after the calibration, or the uncalibrated Rx time delay may be defined as an Rx timing error.

Furthermore, the UE Tx TEG may be associated with the transmissions of one or more UL SRS resources for the positioning purpose, which have the Tx timing errors within a certain margin. Additionally, the TRP Tx TEG may be associated with the transmissions of one or more DL PRS resources, which have the Tx timing errors within a certain margin. In addition, the UE Rx TEG may be associated with one or more DL measurements, which have the Rx timing errors within a certain margin, and the TRP Rx TEG may be associated with one or more UL measurements, which have the Rx timing errors within a margin. Further, the UE RxTx TEG may be associated with one or more UE Rx-Tx time difference measurements, and one or more UL SRS resources for the positioning purpose, which have the “Rx timing errors+Tx timing errors” within a certain margin, and the TRP RxTx TEG may be associated with one or more gNB Rx-Tx time difference measurements and one or more DL PRS resources, which have the “Rx timing errors+Tx timing errors” within a certain margin.

In 3GPP, the UE may be able to provide Rx TEG information associated with a reference signal time difference (RSTD) measurement for downlink-time difference of arrival (DL-TDOA), and the TRP may provide association information of positioning reference signal (PRS) resource(s) with a Tx TEG. That is, conceptually, the UE may inform a location management function (LMF) with which Rx panel/RF chain is used for the RSTD measurement of a PRS resource. Additionally, the LMF may know which Tx panel/RF chain of the TRP is used to transmit the PRS resource. For the UL-based positioning, the UE may provide association information of UL SRS resource(s) with Tx TEG information and the TRP can provide association information RTOA measurements with TRP Rx TEG to the LMF.

3GPP provides support for various techniques mitigating TRP Tx timing errors and/or UE Rx timing errors for DL TDOA. For instance, support may be provided for a UE to provide the association information of RSTD measurements with UE Rx TEG(s) to the LMF when the UE reports the RSTD measurements to the LMF if the UE has multiple TEGs. There may also be support for a TRP providing the association information of DL PRS resources with Tx TEGs to the LMF if the TRP has multiple TEGs, and support for the LMF to provide the association information of DL PRS resources with Tx TEGs to a UE for UE-based positioning if the TRP has multiple TEGs.

Additionally, 3GPP may provide support for various mitigating UE Tx timing errors and/or TRP Rx timing errors for UL TDOA. For example, there may be support for a TRP to provide the association information of RTOA measurements with TRP Rx TEG(s) to the LMF when the TRP reports the RTOA measurements to the LMF if the TRP has multiple Rx TEGs. There may also be support for a UE to provide under capability the association information of UL SRS resources for positioning with Tx TEGs to the LMF if the UE has multiple Tx TEGs.

3GPP further provides two options for providing association information of UL SRS resource(s) with UE Tx TEG. For example, in a first option, subject to the UE's capability, support may be provided for the UE providing the association information of UL SRS resources for positioning with Tx TEGs directly to the LMF if the UE has multiple Tx TEGs, and may provide support for the LMF to forward the association information provided by the UE to the serving and neighboring gNBs. In the first option, LPP signaling may be used for the UE to report the UE Tx TEG associations. In a second option, subject to the UE's capability, support may be provided for the UE providing the association information of UL SRS resources for positioning with Tx TEGs to the serving gNB if the UE has multiple Tx TEGs, and support for the serving gNB to forward the association information provided by the UE to the LMF. In the second option, RRC signaling may be used to report the UE Tx TEG associations. Additionally, the serving gNB may then forward the UE Tx TEG report to the LMF. Further, there may be support for the gNB to report the associated SRS resource ID/resource set ID of the RTOA measurement to the LMF. Additionally, in NR positioning, the UE and TRP may report multiple types of measurements in a single reporting. For example, the UE may report positioning measurements as a set such as (RSTD, DL RSRP, UE Rx-Tx time difference). Similarly, the TRP may report positioning measurements as a set such as (RTOA, UL RSRP, gNB Rx-Tx time difference). Such reporting may be called “Batch Reporting”.

In 3GPP, there may be support for enabling a UE to report one or more measurement instances (of RSTD, DL RSRP, and/or UE Rx-Tx time difference measurements) in a single measurement report to LMF for UE-assisted positioning, and for a TRP to report one or more measurement instances (of RTOA, UL RSRP, and/or gNB Rx-Tx time difference measurements) in a single measurement report to LMF. Additionally, each measurement instance may be reported with its own timestamp.

It may be assumed for mitigating UE Tx timing errors for UL TDOA, subject to UE's capability, support may be provided for the serving gNB to request a UE to provide the association information of UL SRS resources for positioning with Tx TEGs to the serving gNB if the UE supports multiple UE Tx TEGs for UL TDOA. Additionally, the serving gNB may forward the association information provided by the UE to the LMF by NR positioning protocol A (NRPPa) signalling, and the UE may report its capability of supporting multiple UE Tx TEGs for UL TDOA to serving gNB. For mitigating UE Tx timing errors for Multi-RTT, subject to UE's capability, support may be provided for the LMF to request a UE to provide the association information of UL SRS resources for positioning with Tx TEGs directly to the LMF if the UE supports multiple Tx TEGs for Multi-RTT. Further, the UE may report its capability of supporting multiple UE Tx TEGs for Multi-RTT directly to the LMF. However, mitigation of UE Tx timing errors may be needed when multi-RTT, UL-TDOA and/or DL-TDOA are used.

However, in the case of batch reporting where both UL-TDOA and multi-RTT are being used, the gNB may report both RTOA and gNB Rx-Tx time difference measurements. The UE may also report UE Rx-Tx time difference measurements. These three measurements (RTOA, gNB Rx-Tx time difference, and UE Rx-Tx time difference) may be affected by the UE Tx TEG. Further, in LPP, the gNB may be transparent so the serving gNB may not know that the UE is reporting UE Rx-Tx time difference measurements, and may not know if the UE is including UE Tx TEG reports to the LMF. If the gNB does not request the UE to report UE Tx TEG associations and the UE also does not report over LPP, then the LMF may end up with no report. If the LMF has no report, then the LMF has no Tx TEG association information. Additionally, if the gNB requests the UE to report the UE Tx TEG associations and the UE also reports over LPP, then the UE has to report the same information twice. This is unnecessary overhead. In consideration of the dynamic and/or semi-static update of Tx TEG association information, this overhead may not be negligible. As such, certain example embodiments may address the above-described challenges/problems.

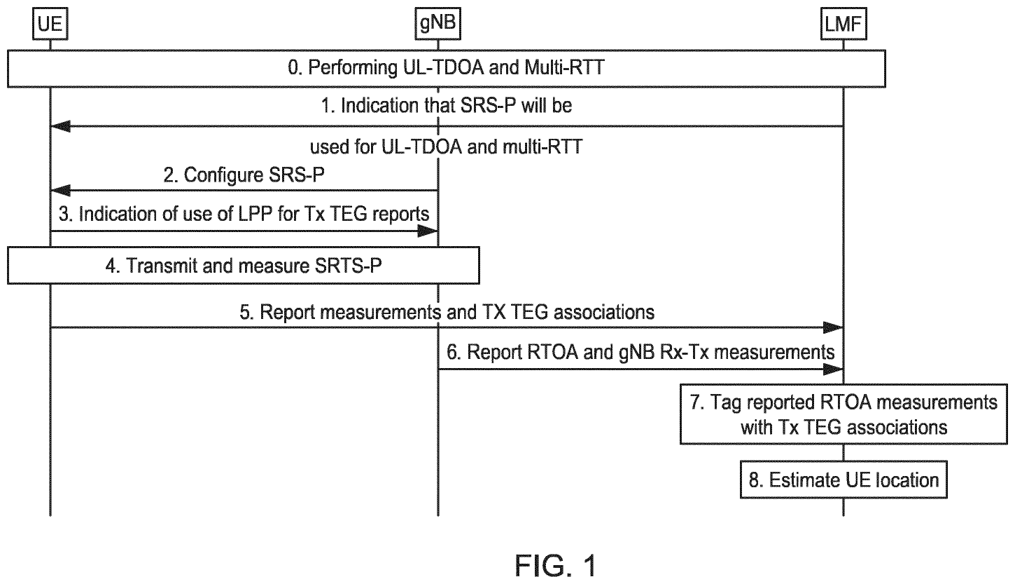

Certain example embodiments may enable a UE to indicate to the gNB if it is reporting UE Tx TEG association reports directly to the LMF. FIG. 1 illustrates an example signal flow diagram, according to certain example embodiments. As illustrated in FIG. 1, at 0, the UE may be performing UL and DL+UL positioning. For example, the UE may be performing UL-TDOA and multi-RTT. At 1, the LMF may inform the UE that the SRS for positioning (SRS-P) resource will be used for both UL-TDOA and multi-RTT. As an example, the gNB may measure RTOA and gNB Rx-Tx time difference based on the SRS-P. According to certain example embodiments, the LMF may inform the UE that the SRS-P resources will be used for RTOA and gNB Rx-Tx time difference measurements by the gNB(s). According to other example embodiments, the measurement made by the network on SRS-P resources may be transparent to the UE.

At 2, the gNB may configure the UE with SRS-P resources, and the UE may associate the resources with UE Tx TEGs. Further, at 3, the UE may inform the serving gNB, via a new RRC message, that the UE will report the UE Tx TEG associations to the LMF via LLP (i.e., radio positioning protocol) directly (e.g., the serving gNB is transparent). In certain example embodiments, this UE behavior may be a response to the Tx TEG request from the gNB. That is, in some example embodiments, the gNB may request the UE to report the UE Tx TEG association information, then the UE may report this new RRC message rather than reporting the Tx TEG association information over RRC. In other example embodiments, the UE may inform the LMF, via a new LLP message, that the UE will report the UE Tx TEG associations to the serving gNB via RRC protocol. According to certain example embodiments, this UE behavior may be a response to the Tx TEG request from the LMF. That is, if the LMF requests the UE to report the UE Tx TEG association information, then the UE may report this new LLP message rather than reporting the Tx TEG association information over LPP.

As further illustrated in FIG. 1, at 4, SRS-P measurements may be made and transmitted between the UE and serving gNB. At 5, the UE may report measurements and Tx TEG associations to the LMF. As an example, the reported measurements may include UE Rx-Tx time differences, RSTD, and/or PRS-RSRP measurements. At 6, the serving gNB does not request UE Tx TEG report from the UE, and forwards the RTOA and gNB Rx-Tx time difference measurement reports to the LMF without UE Tx TEG association information. In certain example embodiments, the gNB may report SRS resource ID(s) used to estimate this RTOA measurement so that the LMF can determine appropriate UE Tx TEG for the RTOA measurement. Additionally, in other example embodiments, the LMF does not request the association report from the UE. Similarly the UE may report the UE Rx-Tx time difference measurement to the LMF without the Tx TEG associations.

At 6, the LMF may use the UE Tx TEG report sent via LPP from the UE to tag (i.e., associated) both the gNB Rx-Tx time difference measurements and the RTOA measurements with the appropriate Tx TEGs. In other example embodiments, the LMF may use the UE Tx TEG report sent from the gNB obtained via RRC from the UE to tag the UE Rx-Tx time difference measurements with the appropriate Tx TEGs. As further illustrated in FIG. 1, at 8, the LMF may continue the position estimation procedure by estimating the UE location. According to certain example embodiments, the LMF may filter which measurements to use based on the TEG associations. For instance, in one example embodiment, the LMF may determine that some TEGs have too large of a error margin, and therefore should be removed from the final positioning calculation.

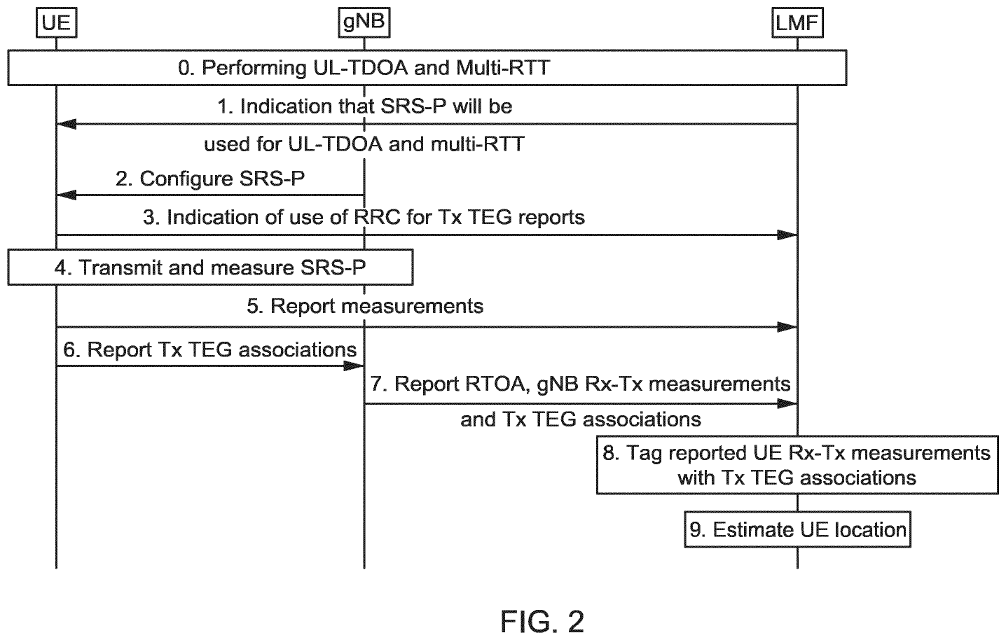

FIG. 2 illustrates another example flow diagram, according to certain example embodiments. As illustrated in FIG. 2, certain operations may be similar to those in FIG. 1 including, for example, operations 0, 1, 2, 4, 5, and 9. As illustrated in FIG. 2, at 3, the UE may transmit to the LMF, an indication of using RRC for Tx TEG reports. At 5, the UE may transmit the measurements and/or the associations. At 6, the UE may transmit a report of the Tx TEG associations to the serving gNB and, at 7, the serving gNB may transmit a report to the LMF of the RTOA, gNB Rx-Tx measurements, and the Tx TEG associations. At 8, the LMF may tag the reported UE Rx-Tx measurements with the appropriate Tx TEG associations.

According to certain example embodiments, as part of a periodic positioning session, the Tx TEG associations may change. In this case the UE may need to inform the network of the change in associations. According to certain example embodiments, the baseline assumption may be that the UE uses the same method as indicated previously (i.e., LPP or RRC) to send the updated associations. This may be enabled by the UE including in the indication of which method it will use that it will also use this for updates of the Tx TEG associations (i.e., including this information in operation 3 shown in FIGS. 1 and 2). In other example embodiments, it may be possible that the methods in use by the LMF change over time, but the UE SRS-P configuration may remain unchanged. For example, the UE may still be transmitting SRS-P, but the LMF is now only using one of multi-RTT or UL-TDOA. In this case the LMF may send an updated indication message to the UE which informs the UE of this to ensure that the UE could make sure to report the Tx TEG associations in the correct way. This may be a new LPP message from the LMF to the UE.

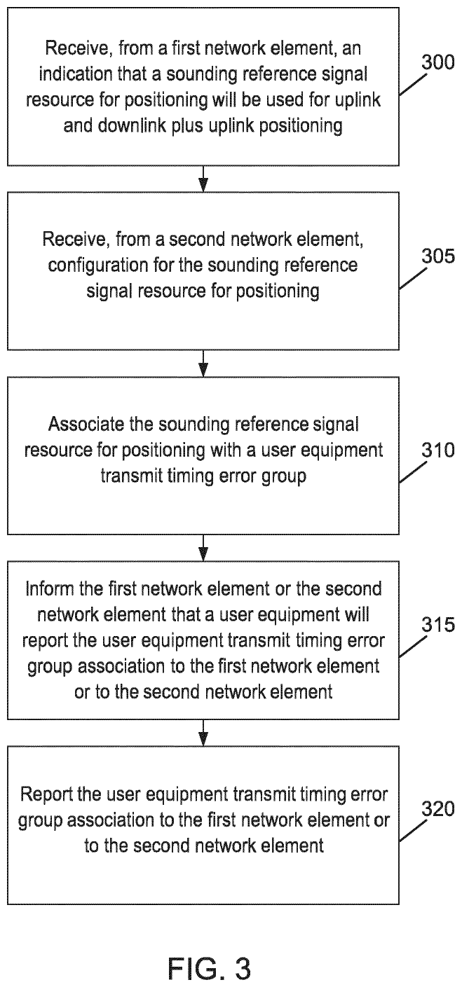

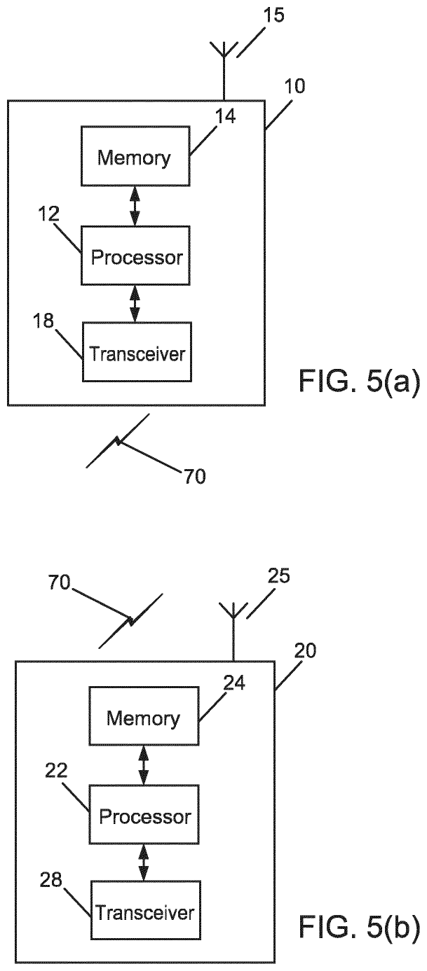

FIG. 3 illustrates an example flow diagram of a method, according to certain example embodiments. In an example embodiment, the method of FIG. 3 may be performed by a network entity, or a group of multiple network elements in a 3GPP system, such as LTE or 5G-NR. For instance, in an example embodiment, the method of FIG. 3 may be performed by a UE similar to one of apparatuses 10 or 20 illustrated in FIGS. 5(a) and 5(b).

According to certain example embodiments, the method of FIG. 3 may include, at 300, receiving, from a first network element, an indication that a sounding reference signal for positioning resource will be used for uplink time difference of arrival and multi-cell round trip time. At 305, the method may include receiving, from a second network element, configuration for the sounding reference signal positioning resource. At 310, the method may include associating the sounding reference signal positioning resource with a user equipment transmit timing error group. At 315, the method may include informing the first network element or the second network element that a user equipment will report the user equipment transmit timing error group association to the first network element or to the second network element. At 320, the method may include reporting the user equipment transmit timing error group association to the first network element or to the second network element.

According to certain example embodiments, the first network element may be informed via a radio resource control message. According to some example embodiments, the user equipment transmit timing error group association may be reported to the first network element directly via a radio positioning protocol (e.g., the gNB is transparent). According to other example embodiments, reporting the user equipment transmit timing error group association to the first network element may be in response to receiving a request from the second network element to report the user equipment transmit timing error group association. In certain example embodiments, the second network element may be informed via a radio positioning protocol message. In some example embodiments, the user equipment transmit timing error group association may be reported to the second network element via a radio resource control protocol. In other example embodiments, reporting the user equipment transmit timing error group association to the second network element may be in response to receiving a request from the first network element to report the user equipment transmit timing error group association.

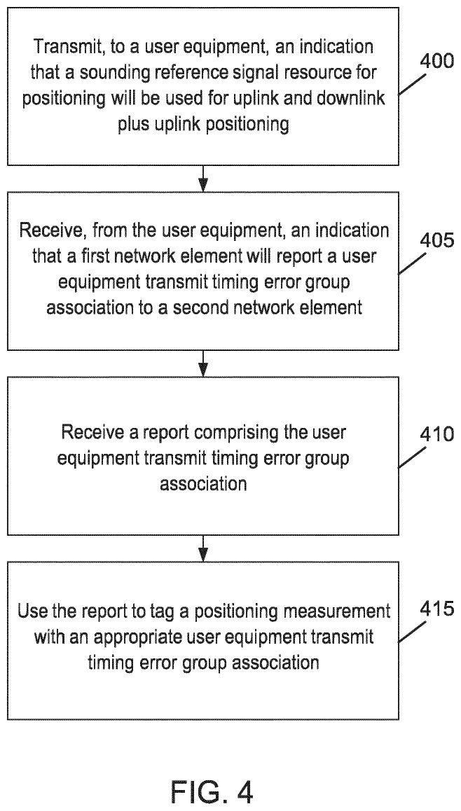

FIG. 4 illustrates an example flow diagram of another method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a core network element such as, for example, an LMF, or other core network elements similar to one of apparatuses 10 or 20 illustrated in FIGS. 5(a) and 5(b). In some example embodiments, an LMF may be implemented in an RAN and/or a local location management component (LMC).

According to certain example embodiments, the method of FIG. 4 may include, at 400, transmitting, to a user equipment, an indication that a sounding reference signal resource for positioning will be used for uplink time difference of arrival and multi-cell round trip time. At 405, the method may include receiving, from the user equipment, an indication that a first network element will report a user equipment transmit timing error group association to a second network element. At 410, the method may include receiving a report comprising the user equipment transmit timing error group association. At 415, the method may include using the report to tag a radio measurement with an appropriate user equipment transmit timing error group association.

According to certain example embodiments, the report may be received from the user equipment or the first network element. According to some example embodiments, the report may include relative time of arrival measurements and first network element receive-transmit measurements. According to other example embodiments, the tagging may include tagging the relative time of arrival measurements and the first network element receive-transmit measurements with the appropriate user equipment transmit timing error group association. In certain example embodiments, the method may also include receiving, from the user equipment, a user equipment receive-transmit time difference measurement.

FIG. 5(a) illustrates an apparatus 10 according to certain example embodiments. In certain example embodiments, the apparatus 10 may be a node or element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 5(a).

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 5(a).

As illustrated in the example of FIG. 5(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5(a), multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-3.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-3.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a first network element, an indication that a sounding reference signal for positioning resource will be used for uplink time difference of arrival and multi-cell round trip time. Apparatus 10 may also be controlled by memory 14 and processor 12 to receive, from a second network element, configuration for the sounding reference signal positioning resource. Apparatus 10 may further be controlled by memory 14 and processor 12 to associate the sounding reference signal positioning resource with a user equipment transmit timing error group. In addition, apparatus 10 may be controlled by memory 14 and processor 12 to inform the first network element or the second network element that the apparatus will report the user equipment transmit timing error group association to the first network element or to the second network element. Further, apparatus 10 may be controlled by memory 14 and processor 12 to report the user equipment transmit timing error group association to the first network element or to the second network element.

FIG. 5(b) illustrates an apparatus 20 according to certain example embodiments. In certain example embodiments, the apparatus 20 may be a node, core network element, or element in a communications network or associated with such a network, such as an LMF or gNB. It should be noted that one of ordinary skill in the art would understand that apparatus 20 may include components or features not shown in FIG. 5(b).

As illustrated in the example of FIG. 5(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5(b), multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1, 2, and 4.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1, 2, and 4.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to transmit, to a user equipment, an indication that a sounding reference signal for positioning resource will be used for uplink time difference of arrival and multi-cell round trip time. Apparatus 20 may also be controlled by memory 24 and processor 22 to receive, from the user equipment, an indication that network element will report a user equipment transmit timing error group association to the apparatus. Apparatus 20 may further be controlled by memory 24 and processor 22 to receive a report comprising the user equipment transmit timing error group association. In addition, apparatus 20 may be controlled by memory 24 and processor 22 to use the report to tag a radio measurement with an appropriate user equipment transmit timing error group association.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving, from a first network element, an indication that a sounding reference signal for positioning resource will be used for uplink time difference of arrival and multi-cell round trip time. The apparatus may also include means for receiving, from a second network element, configuration for the sounding reference signal positioning resource. The apparatus may further include means for associating the sounding reference signal positioning resource with a user equipment transmit timing error group. In addition, the apparatus may include means for informing the first network element or the second network element that the apparatus will report the user equipment transmit timing error group association to the first network element or to the second network element. Further, the apparatus may include means for reporting the user equipment transmit timing error group association to the first network element or to the second network element.

Certain example embodiments may also be directed to an apparatus that includes means for transmitting, to a user equipment, an indication that a sounding reference signal for positioning resource will be used for uplink time difference of arrival and multi-cell round trip time. The apparatus may also include means for receiving, from the user equipment, an indication that network element will report a user equipment transmit timing error group association to the apparatus. The apparatus may further include means for receiving a report comprising the user equipment transmit timing error group association. In addition, the apparatus may include means for using the report to tag a radio measurement with an appropriate user equipment transmit timing error group association.

Certain example embodiments described herein provide several technical improvements, enhancements, and/or advantages. In some example embodiments, it may be possible to reduce overhead, improve positioning accuracy, provide UE power saving, and improve network efficiency.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:

| | |
|---|---|
| 3GPP | 3rd Generation Partnership Project |
| 5G | 5th Generation |
| 5GCN | 5G Core Network |
| 5GS | 5G System |
| BS | Base Station |
| CN | Core Network |
| DL | Downlink |
| eNB | Enhanced Node B |
| gNB | 5G or Next Generation NodeB |
| LTE | Long Term Evolution |
| LMC | Local Location Management Component |
| LMF | Location Management Function |
| LPP | LTE Positioning Protocol |
| Multi-RTT | Multi-Cell Round Trip Time |
| NR | New Radio |
| NRPPa | New Radio Positioning Protocol A |
| PRS | Positioning Reference Signal |
| QoS | Quality of Service |
| RLCR | Radio Link Capability Report |
| RRC | Radio Resource Control |
| RTOA | Relative Time of Arrival |
| Rx-Tx | Receive-Transmit |
| TEG | Transmit Error Group |
| TRP | Transmission Reception Point |
| TSC | Time Sensitive Communications |
| Tx-TEG | Transmit Timing Error Group |
| UE | User Equipment |
| UL | Uplink |
| UL-TDOA | Uplink Time Difference of Arrival |
| URLLC | Ultra-Reliable Low-Latency Communications |

1. A method, comprising:
receiving, from a first network element, an indication that a sounding reference signal resource for positioning will be used for uplink and downlink plus uplink positioning;
receiving, from a second network element, configuration for the sounding reference signal resource for positioning;
associating the sounding reference signal resource for positioning with a user equipment transmit timing error group;
informing the first network element or the second network element that a user equipment will report the user equipment transmit timing error group association to the first network element or to the second network element; and
reporting the user equipment transmit timing error group association to the first network element or to the second network element.

2. The method according to claim 1, wherein the first network element is informed via a long term evolution positioning protocol.

3. The method according to claim 1,
wherein the user equipment transmit timing error group association is reported to the first network element directly via a radio positioning protocol, and
wherein reporting the user equipment transmit timing error group association to the first network element is in response to receiving a request from the second network element to report the user equipment transmit timing error group association.

4. The method according to claim 1, wherein the second network element is informed via a radio resource control.

5. The method according to claim 1,
wherein the user equipment transmit timing error group association is reported to the second network element via a radio resource control message, and
wherein reporting the user equipment transmit timing error group association to the second network element is in response to receiving a request from the first network element to report the user equipment transmit timing error group association.

6. The method according to claim 1, further comprising:
receiving, from a first network element, an indication that a sounding reference signal resource for positioning will be used for uplink time difference of arrival and multi-cell round trip time.

7. A method, comprising:
transmitting, to a user equipment, an indication that a sounding reference signal resource for positioning will be used for uplink and downlink plus uplink positioning;
receiving, from the user equipment, an indication that a first network element will report a user equipment transmit timing error group association to a second network element;
receiving a report comprising the user equipment transmit timing error group association; and
using the report to tag a positioning measurement with an appropriate user equipment transmit timing error group association.

8. The method according to claim 7, wherein the report is received from the user equipment or the first network element.

9. The method according to claim 7, wherein the report comprises relative time of arrival measurements and first network element receive-transmit measurements.

10. The method according to claim 9, wherein the tagging comprises tagging the relative time of arrival measurements and the first network element receive-transmit measurements with the appropriate user equipment transmit timing error group association.

11. The method according to claim 7, further comprising:
receiving, from the user equipment, a user equipment receive-transmit time difference measurement.

12. An apparatus, comprising:
at least one processor; and
at least one memory comprising computer program code,
the at least one memory and the computer program code are configured, with the at least one processor to cause the apparatus at least to
receive, from a first network element, an indication that a sounding reference signal resource for positioning will be used for uplink and downlink plus uplink positioning;
receive, from a second network element, configuration for the sounding reference signal resource for positioning;
associate the sounding reference signal resource for positioning with a user equipment transmit timing error group;
inform the first network element or the second network element that the apparatus will report the user equipment transmit timing error group association to the first network element or to the second network element; and
report the user equipment transmit timing error group association to the first network element or to the second network element.

13. The apparatus according to claim 12, wherein the first network element is informed via a long term evolution positioning protocol.

14. The apparatus according to claim 12,
wherein the user equipment transmit timing error group association is reported to the first network element directly via a radio positioning protocol, and
wherein reporting the user equipment transmit timing error group association to the first network element is in response to receiving a request from the second network element to report the user equipment transmit timing error group association.

15. The apparatus according to claim 12, wherein the second network element is informed via a radio resource control.

16. The apparatus according to claim 12,
wherein the user equipment transmit timing error group association is reported to the second network element via a radio resource control message, and
wherein reporting the user equipment transmit timing error group association to the second network element is in response to receiving a request from the first network element to report the user equipment transmit timing error group association.

17. The apparatus according to claim 12, wherein the at least one memory and the computer program code are further configured, with the at least one processor to cause the apparatus at least to
receive an indication that a sounding reference signal resource for positioning will be used for uplink time difference of arrival and multi-cell round trip time.

18. An apparatus, comprising:
at least one processor; and
at least one memory comprising computer program code,
the at least one memory and the computer program code are configured, with the at least one processor to cause the apparatus at least to
transmit, to a user equipment, an indication that a sounding reference signal resource for positioning will be used for uplink time difference of arrival and multi-cell round trip time;
receive, from the user equipment, an indication that network element will report a user equipment transmit timing error group association to the apparatus;
receive a report comprising the user equipment transmit timing error group association; and
use the report to tag a positioning measurement with an appropriate user equipment transmit timing error group association.

19. The apparatus according to claim 18, wherein the report is received from the user equipment or the first network element.

20. The apparatus according to claim 18, wherein the report comprises relative time of arrival measurements and first network element receive-transmit measurements

21. The apparatus according to claim 20, wherein the tagging comprises tagging the relative time of arrival measurements and the first network element receive-transmit measurements with the appropriate user equipment transmit timing error group association.

22. The apparatus according to claim 18, wherein the at least one memory and the computer program code are further configured, with the at least one processor to cause the apparatus at least to:
receive, from the user equipment, a user equipment receive-transmit time difference measurement.

23-35. (canceled)
